(19) United States
(12) Patent Application Publication
(10) Pub. No.: US 2024/0117239 A1
(43) Pub. Date: Apr. 11, 2024

(54) COMBINATION PRODUCTS CONTAINING ANTI-AGGLOMERANT LOW DOSE HYDRATE INHIBITORS AND CORROSION INHIBITORS WITH IMPROVED CORROSION RESISTANCE

(71) Applicant: ChampionX LLC, Sugar Land, TX (US)

(72) Inventors: Geeta Rana, Sugar Land, TX (US); Jeremy Moloney, Katy, TX (US); Jeremy Bartels, Sugar Land, TX (US); Pritesh Sharma, Missouri City, TX (US)

(21) Appl. No.: 18/461,676

(22) Filed: Sep. 6, 2023

Related U.S. Application Data
(60) Provisional application No. 63/374,685, filed on Sep. 6, 2022.

(51) Int. Cl. C09K 8/54; C09K 8/528

(52) U.S. Cl. CPC C09K 8/54; C09K 8/528; C09K 2208/22

(57) ABSTRACT

Hydrate inhibitor and corrosion inhibitor composition are disclosed and include from about 10 wt-% to about 99.9 wt-% of an anti-agglomerant low dose hydrate inhibitor (AA-LDHI), wherein the AA-LDHI is a zwitterionic compound or a cationic ammonium compound; from about 0.01 wt-% to about 50 wt-% of a corrosion inhibitor, and at least one additional functional ingredient, solvent, or a combination thereof. Methods for inhibiting corrosion and formation of gas hydrate agglomerants in a fluid are disclosed and include contacting the fluid with a hydrate inhibitor and corrosion inhibitor composition or contacting the fluid with an AA-LDHI, wherein the AA-LDHI is a zwitterionic compound or a cationic ammonium compound, and a corrosion inhibitor, wherein the AA-LDHI and corrosion inhibitor are provided at a weight ratio of about 1:0.001 to about 1:1, and wherein the composition inhibits general and localized corrosion and formation of gas hydrate agglomerants in the fluid.

### CROSS-REFERENCE TO RELATED APPLICATION

This application claims priority under 35 U.S.C. § 119 to Provisional Application U.S. Ser. No. 63/374,685, filed on Sep. 6, 2022, which is herein incorporated by reference in its entirety including without limitation, the specification, claims, and abstract, as well as any figures, tables, or examples thereof.

### FIELD

The disclosure relates generally to compositions and methods for reducing or inhibiting the growth, formation, and/or agglomeration of hydrate particles in fluids while also inhibiting corrosion. More specifically, the disclosure relates to combinational use of anti-agglomerate low dose hydrate inhibitors and corrosion inhibitors providing corrosion inhibition and reducing or inhibiting hydrate agglomeration in the production and transport of petroleum fluids, including mixtures of varying amounts of water/brine, crude oil/condensate, and natural gas.

### BACKGROUND

A significant risk to oil and gas production infrastructure is accelerated internal pipeline corrosion. The production of oil and gas reservoirs present corrosive environments that place the internal metallurgy of process equipment (e.g., transport pipelines, flow lines, separation equipment), often constructed of mild carbon steel, at risk for failure. The rate of corrosion deterioration in oil and gas field equipment metallurgy is dependent upon production parameters such as oil/water ratio, fluid brine composition, temperature, pH, and the concentration of corrosive gases typically present in the reservoir formation, such as CO₂, H₂S, or combinations thereof.

In order to preserve the integrity of oil and gas infrastructure, corrosion inhibitors are added into production fluids upstream of piping infrastructure intended to be protected. In general, corrosion inhibitors of this type protect the metal through formation of a passivation film on the metal surface. This passivation layer oil wets the metal surface, which in turn prevents contact of the metal from the corrosive nature of the produced reservoir fluids. Typically, corrosion inhibitor formulations of this type contain a variety of aliphatic organic surfactant molecules ranging from, but not limited to, amines, quaternary amines, imidazolines, phosphate esters, amides, carboxylic acids, or combinations thereof.

In addition to corrosion, another challenge are gas hydrates known to block gas pipelines and therefore the prevention of hydrate formation and agglomeration has become a requirement in the oil and gas industry. Natural gas hydrates are crystalline solids composed of water and gas. Gas hydrates can easily form during the transportation of oil and gas in pipelines when the appropriate conditions are present, such as water content, low temperatures, and elevated pressure, causing the ice-like gas hydrate solids to form from the small, nonpolar molecules and water. Under these conditions, the water molecules can form cage-like structures around these small nonpolar molecules (typically dissolved gases such as carbon dioxide, hydrogen sulfide, methane, ethane, propane, butane and iso-butane), creating a type of host-guest interaction also known as a clathrate or clathrate hydrate. The specific architecture of these structures can vary. However, once formed, they tend to settle out from the solution and accumulate into large solid masses that can travel by oil and gas transporting pipelines, and potentially block or damage the pipelines and/or related equipment. The formation of gas hydrates can cause damage, including resulting from a blockage, that can be very costly from an equipment repair standpoint, as well as from the loss of production, and finally the resultant environmental impact. As a result, the formation of gas hydrates often results in lost oil production and pipeline damage.

Modern oil and gas technologies commonly operate under severe conditions during the course of oil recovery and production, such as high pumping speed, high pressure in the pipelines, extended length of pipelines, and low temperature of the oil and gas flowing through the pipelines. These conditions are particularly favorable for the formation of gas hydrates, which is an undesirable outcome. Various classes of hydrate inhibitors are used to prevent blockages, such as thermodynamic hydrate inhibitors (THI), anti-agglomerant hydrate inhibitors (AAs), and kinetic hydrate inhibitors (KHIs). The amount of chemical needed to prevent blockages varies widely depending upon the type of inhibitor employed. Thermodynamic hydrate inhibitors are substances that can reduce the temperature at which the hydrates form at a given pressure and water content, and are typically used at very high concentrations. Therefore, there is a substantial cost associated with the transportation and storage of large quantities of these solvents. A more cost-effective alternative is the use of low dosage hydrate inhibitors (LDHIs), as they generally require a dose of less than about 2% to inhibit the nucleation or growth of gas hydrates. There are two general types of LDHIs, kinetic hydrate inhibitors and anti-agglomerants which are both typically used at much lower concentrations. KHIs work by delaying the growth of gas hydrate crystals. They also function as anti-nucleators. In contrast, AAs allow hydrates to form but they prevent them from agglomerating and subsequently accumulating into larger masses capable of causing plugs. The function of an AA is to keep hydrate particles dispersed as a fluid slurry within the hydrocarbon phase.

Thus, there exists a need in the art for enhanced treatment compositions for combined corrosion inhibition and hydrate inhibition.

It is therefore an object of this disclosure to provide a hydrate inhibitor and corrosion inhibitor composition that simultaneously provides effective hydrate inhibition and localized corrosion inhibition.

It is a further object of the disclosure to provide methods for inhibiting corrosion and formation of gas hydrate agglomerants in a fluid superior to conventional treatments.

Other objects, embodiments and advantages of this disclosure will be apparent to one skilled in the art in view of the following disclosure, the drawings, and the appended claims.

### BRIEF SUMMARY

The following objects, features, advantages, aspects, and/or embodiments, are not exhaustive and do not limit the overall disclosure. No single embodiment need provide each and every object, feature, or advantage. Any of the objects, features, advantages, aspects, and/or embodiments disclosed herein can be integrated with one another, either in full or in part. It is a primary object, feature, and advantage of the present disclosure to provide a hydrate inhibitor and corrosion inhibitor composition that simultaneously provides effective hydrate inhibition and localized corrosion inhibition.

According to some aspects of the present disclosure, a hydrate inhibitor and corrosion inhibitor composition comprises: from about 10 wt-% to about 99.9 wt-% of an anti-agglomerant low dose hydrate inhibitor (AA-LDHI), wherein the AA-LDHI is a zwitterionic compound or a cationic ammonium compound; from about 0.01 wt-% to about 50 wt-% of a corrosion inhibitor; and at least one additional functional ingredient, solvent, or a combination thereof.

According to an additional aspect of the present disclosure, method for inhibiting corrosion and formation of gas hydrate agglomerants in a fluid comprises: contacting the fluid with a hydrate inhibitor and corrosion inhibitor composition as described herein, or contacting the fluid with an anti-agglomerant low dose hydrate inhibitor (AA-LDHI), wherein the AA-LDHI is a zwitterionic compound or a cationic ammonium compound, and a corrosion inhibitor, wherein the AA-LDHI and corrosion inhibitor are provided at a weight ratio of about 1:0.001 to about 1:1, wherein the composition inhibits general and localized corrosion and formation of gas hydrate agglomerants in the fluid.

These and/or other objects, features, advantages, aspects, and/or embodiments will become apparent to those skilled in the art after reviewing the following brief and detailed descriptions of the drawings. Furthermore, the present disclosure encompasses aspects and/or embodiments not expressly disclosed but which can be understood from a reading of the present disclosure, including at least: (a) combinations of disclosed aspects and/or embodiments and/or (b) reasonable modifications not shown or described.

While multiple embodiments are disclosed, still other embodiments will become apparent to those skilled in the art from the following detailed description, which shows and describes illustrative embodiments. Accordingly, the drawings and detailed description are to be regarded as illustrative in nature and not restrictive.

### DETAILED DESCRIPTION

The present disclosure is not to be limited to that described herein, which can vary and are understood by skilled artisans. No features shown or described are essential to permit basic operation of the present disclosure unless otherwise indicated. It is further to be understood that all terminology used herein is for the purpose of describing particular embodiments only, and is not intended to be limiting in any manner or scope. For example, as used in this specification and the appended claims, the singular forms “a,” “an” and “the” can include plural referents unless the content clearly indicates otherwise. Further, all units, prefixes, and symbols may be denoted in its SI accepted form.

Numeric ranges recited within the specification are inclusive of the numbers defining the range and include each integer within the defined range. Throughout this disclosure, various aspects of this disclosure are presented in a range format. It should be understood that the description in range format is merely for convenience and brevity and should not be construed as an inflexible limitation on the scope of the disclosure. Accordingly, the description of a range should be considered to have specifically disclosed all the possible sub-ranges, fractions, and individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6, and decimals and fractions, for example, 1.2, 3.8, 1½, and 4¾. This applies regardless of the breadth of the range.

As used herein, the term “and/or”, e.g., “X and/or Y” shall be understood to mean either “X and Y” or “X or Y” and shall be taken to provide explicit support for both meanings or for either meaning, e.g. A and/or B includes the options i) A, ii) B or iii) A and B.

It is to be appreciated that certain features that are, for clarity, described herein in the context of separate embodiments, may also be provided in combination in a single embodiment. Conversely, various features that are, for brevity, described in the context of a single embodiment, may also be provided separately or in any sub-combination.

The methods and compositions of the present disclosure may comprise, consist essentially of, or consist of the components and ingredients of the present disclosure as well as other ingredients described herein. As used herein, “consisting essentially of” means that the methods, systems, apparatuses and compositions may include additional steps, components or ingredients, but only if the additional steps, components or ingredients do not materially alter the basic and novel characteristics of the claimed methods, systems, apparatuses, and compositions.

Unless defined otherwise, all technical and scientific terms used above have the same meaning as commonly understood by one of ordinary skill in the art to which embodiments of the present disclosure pertain.

The terms “invention” or “present invention” are not intended to refer to any single embodiment of the particular invention but encompass all possible embodiments as described in the specification and the claims.

The term “about,” as used herein, refers to variation in the numerical quantity that can occur, for example, through typical measuring techniques and equipment, with respect to any quantifiable variable, including, but not limited to, mass, volume, time, temperature, pH, and log count of bacteria or viruses. Further, given solid and liquid handling procedures used in the real world, there is certain inadvertent error and variation that is likely through differences in the manufacture, source, or purity of the ingredients used to make the compositions or carry out the methods and the like. The term “about” also encompasses these variations. Whether or not modified by the term “about,” the claims include equivalents to the quantities.

The term “actives” or “percent actives” or “percent by weight actives” or “actives concentration” are used interchangeably herein and refers to the concentration of those ingredients involved in cleaning expressed as a percentage minus inert ingredients such as water or salts. It is also sometimes indicated by a percentage in parentheses, for example, “chemical (10%).”

As used herein, the term “alkyl” or “alkyl groups” refers to saturated hydrocarbons having one or more carbon atoms, including straight-chain alkyl groups (e.g., methyl, ethyl, propyl, butyl, pentyl, hexyl, heptyl, octyl, nonyl, decyl, etc.), cyclic alkyl groups (or “cycloalkyl” or “alicyclic” or “carbocyclic” groups) (e.g., cyclopropyl, cyclopentyl, cyclohexyl, cycloheptyl, cyclooctyl, etc.), branched-chain alkyl groups (e.g., isopropyl, tert-butyl, sec-butyl, isobutyl, etc.), and alkyl-substituted alkyl groups (e.g., alkyl-substituted cycloalkyl groups and cycloalkyl-substituted alkyl groups).

Unless otherwise specified, the term “alkyl” includes both “unsubstituted alkyls” and “substituted alkyls.” As used herein, the term “substituted alkyls” refers to alkyl groups having substituents replacing one or more hydrogens on one or more carbons of the hydrocarbon backbone. Such substituents may include, for example, alkenyl, alkynyl, halogeno, hydroxyl, alkylcarbonyloxy, arylcarbonyloxy, alkoxycarbonyloxy, aryloxy, aryloxycarbonyloxy, carboxylate, alkylcarbonyl, arylcarbonyl, alkoxycarbonyl, aminocarbonyl, alkylaminocarbonyl, dialkylaminocarbonyl, alkylthiocarbonyl, alkoxyl, phosphate, phosphonato, phosphinato, cyano, amino (including alkyl amino, dialkylamino, arylamino, diarylamino, and alkylarylamino), acylamino (including alkylcarbonylamino, arylcarbonylamino, carbamoyl and ureido), imino, sulfhydryl, alkylthio, arylthio, thiocarboxylate, sulfates, alkylsulfinyl, sulfonates, sulfamoyl, sulfonamido, nitro, trifluoromethyl, cyano, azido, heterocyclic, alkylaryl, or aromatic (including heteroaromatic) groups.

In some embodiments, substituted alkyls can include a heterocyclic group. As used herein, the term “heterocyclic group” includes closed ring structures analogous to carbocyclic groups in which one or more of the carbon atoms in the ring is an element other than carbon, for example, nitrogen, sulfur or oxygen. Heterocyclic groups may be saturated or unsaturated. Exemplary heterocyclic groups include, but are not limited to, aziridine, ethylene oxide (epoxides, oxiranes), thiirane (episulfides), dioxirane, azetidine, oxetane, thietane, dioxetane, dithietane, dithiete, azolidine, pyrrolidine, pyrroline, oxolane, dihydrofuran, and furan.

The terms “aryl” or “ar” as used herein alone or as part of another group (e.g., aralkyl) denote optionally substituted homocyclic aromatic groups, preferably monocyclic or bicyclic groups containing from 6 to 12 carbons in the ring portion, such as phenyl, biphenyl, naphthyl, substituted phenyl, substituted biphenyl or substituted naphthyl. Phenyl and substituted phenyl are the more preferred aryl. The term “aryl” also includes heteroaryl.

“Arylalkyl” means an aryl group attached to the parent molecule through an alkylene group. In some embodiments the number of carbon atoms in the aryl group and the alkylene group is selected such that there is a total of about 6 to about 18 carbon atoms in the arylalkyl group. A preferred arylalkyl group is benzyl.

The term “configured” describes structure capable of performing a task or adopting a particular configuration. The term “configured” can be used interchangeably with other similar phrases, such as constructed, arranged, adapted, manufactured, and the like. Terms characterizing sequential order, a position, and/or an orientation are not limiting and are only referenced according to the views presented.

The term “-ene” as used as a suffix as part of another group denotes a bivalent substituent in which a hydrogen atom is removed from each of two terminal carbons of the group, or if the group is cyclic, from each of two different carbon atoms in the ring. For example, alkylene denotes a bivalent alkyl group such as methylene (—CH₂—) or ethylene (—CH₂CH₂—), and arylene denotes a bivalent aryl group such as o-phenylene, m-phenylene, or p-phenylene.

As used herein, the term “exemplary” refers to an example, an instance, or an illustration, and does not indicate a most preferred embodiment unless otherwise stated.

As used herein, the term “free” refers to compositions completely lacking the component or having such a small amount of the component that the component does not affect the performance of the composition. The component may be present as an impurity or as a contaminant and shall be less than 0.5 wt-%, less than 0.1 wt-% and in yet another embodiment, the amount of component is less than 0.01 wt-% or 0 wt-%.

The term “generally” encompasses both “about” and “substantially.”

The term “inhibiting” as referred to herein includes both inhibiting and preventing, such as in reference to corrosion and the formation and agglomeration of hydrate crystals.

As used herein the term “polymer” refers to a molecular complex comprised of a more than ten monomeric units and generally includes, but is not limited to, homopolymers, copolymers, such as for example, block, graft, random and alternating copolymers, terpolymers, and higher “x”mers, further including their analogs, derivatives, combinations, and blends thereof. Furthermore, unless otherwise specifically limited, the term “polymer” shall include all possible isomeric configurations of the molecule, including, but are not limited to isotactic, syndiotactic and random symmetries, and combinations thereof. Furthermore, unless otherwise specifically limited, the term “polymer” shall include all possible geometrical configurations of the molecule.

The “scope” of the present disclosure is defined by the appended claims, along with the full scope of equivalents to which such claims are entitled. The scope of the disclosure is further qualified as including any possible modification to any of the aspects and/or embodiments disclosed herein which would result in other embodiments, combinations, subcombinations, or the like that would be obvious to those skilled in the art.

The term “substantially” refers to a great or significant extent. “Substantially” can thus refer to a plurality, majority, and/or a supermajority of said quantifiable variable, given proper context.

As used herein, the term “substantially free” refers to compositions completely lacking the component or having such a small amount of the component that the component does not affect the performance of the composition. The component may be present as an impurity or as a contaminant and shall be less than 0.5 wt-%.

The term “substituted” as in “substituted aryl,” “substituted alkyl,” and the like, means that in the group in question (i.e., the alkyl, aryl or other group that follows the term), at least one hydrogen atom bound to a carbon atom is replaced with one or more substituent groups such as hydroxy (—OH), alkylthio, phosphino, amido (—CON(R_{A})(R_{B}), wherein R_{A} and R_{B} are independently hydrogen, alkyl, or aryl), amino(—N(R_{A})(R_{B}), wherein R_{A} and R_{B} are independently hydrogen, alkyl, or aryl), halo (fluoro, chloro, bromo, or iodo), silyl, nitro (—NO₂), an ether (—OR_{A} wherein R_{A} is alkyl or aryl), an ester (—OC(O)R_{A} wherein R_{A} is alkyl or aryl), keto (—C(O)R_{A} wherein R_{A} is alkyl or aryl), heterocyclo, and the like. Further, an alkylene group in the chain can be replaced with an ether, an amine, an amide, a carbonyl, an ester, a cycloalkyl, or a heterocyclo functional group. When the term “substituted” introduces a list of possible substituted groups, it is intended that the term apply to every member of that group. That is, the phrase “optionally substituted alkyl or aryl” is to be interpreted as “optionally substituted alkyl or optionally substituted aryl.”

The term “surfactant” or “surface active agent” refers to an organic chemical that when added to a liquid changes the properties of that liquid at a surface.

The term “weight percent,” “wt-%,” “percent by weight,” “% by weight,” and variations thereof, as used herein, refer to the concentration of a substance as the weight of that substance divided by the total weight of the composition and multiplied by 100. It is understood that, as used here, “percent,” “%,” and the like are intended to be synonymous with “weight percent,” “wt-%,” etc.

### COMPOSITIONS

According to embodiments, the compositions for inhibiting corrosion and gas hydrate agglomeration to effectively control corrosion and gas hydrate formation and plugging in hydrocarbon production and transportation systems are disclosed herein. The compositions include an anti-agglomerant low dose hydrate inhibitor (AA-LDHI), a corrosion inhibitor, and a solvent. The compositions can include additional functional ingredients and can be provided as concentrate or use compositions. Exemplary compositions are shown in Table 1 in weight percentage.

While the components may have a percent actives of 100%, it is noted that Table 1 does not recite the percent actives of the components, but rather, recites the total weight percentage of the raw materials (i.e. active concentration plus inert ingredients) if provided in a single composition.

TABLE 1

| | First | Second | Third |
|---|---|---|---|
| | Exemplary | Exemplary | Exemplary |
| Material | Range wt.-% | Range wt.-% | Range wt.-% |
| AA-LDHI | 10-99.9 | 20-99.9 | 50-99.9 |
| Corrosion Inhibitor | 0.001-50 | 0.005-20 | 0.01-10 |
| Solvent | 0-10 | 0-8 | 0-5 |
| Additional Functional | 0.0001-20 | 0.001-10 | 0.001-5 |
| Ingredients | | | |

The composition (and methods employing the AA-LDHI and CIs) are preferably free of kinetic hydrate inhibitors, including for example those disclosed in U.S. Pat. No. 8,821,754 and WO93/25798. The compositions (and methods employing the AA-LDHI and CIs) are further preferably free of fluoroalkyl compounds. In still further embodiments, the composition (and methods employing the AA-LDHI and CIs) are preferably free of kinetic hydrate inhibitors and fluoroalkyl compounds.

### Anti-Agglomerant Low Dose Hydrate Inhibitors

The composition comprises at least one anti-agglomerant low dose hydrate inhibitor (AA-LDHI). AA-LDHI in the compositions can include zwitterionic compounds and cationic ammonium compound.

The zwitterionic AA-LDHI included in the hydrate inhibitor and corrosion inhibitor compositions can include a compound of Formula (I), or an acid, a free base, a zwitterion, or a salt thereof:

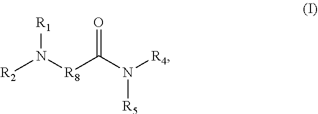

wherein R₁ is hydrogen, a C₁ to C₂₀ substituted or unsubstituted alkyl group, or a C₁ to C₂₀ substituted or unsubstituted alkenyl group; R₂ is hydrogen, a C₁ to C₂₀ substituted or unsubstituted alkyl group, or a C₁ to C₂₀ substituted or unsubstituted alkenyl group, an alkylcarboxyl, or an alkylamido group; R₄ and R₅ are independently hydrogen, a C₁ to C₂₀ substituted or unsubstituted alkyl group, a C₁ to C₂₀ substituted or unsubstituted alkenyl group, or wherein the nitrogen atom and the R₄ and R₅ groups form a substituted or unsubstituted heterocyclo group; and R₈ is a C₂ to C₁₀ substituted or unsubstituted alkylene group.

The substituted alkyl group of R₁, R₂, R₄, and R₅ can have at least one of the —CH₂— groups in the chain replaced with an ether, an amine, an amide, a carbonyl, or an ester functional group or can have at least one of the hydrogen atoms attached to a carbon atom of the chain be replaced with a hydroxy, a halo, or an amine group. The substituted alkyl group of R₁, R₂, R₄, and R₅ can also have at least one of the —CH₂— groups in the chain replaced with an amine. The compound of Formula (I) can have R₈ be —C₂H₄—. Additionally, the compound of Formula (I) can have R₁ be C₁₀ to C₂₀ alkyl or —R₁₀—NR₆R₇, wherein R₁₀ is C₁ to C₅ alkylene, and R₆ and R₇ are independently substituted or unsubstituted C₁ to C₆ alkyl. Further, the compound of Formula (I), R₂ can be —R₂₀—C(O)O—, wherein R₂₀ is C₁ to C₄ alkylene. For the compound of Formula (I), R₄ can be hydrogen. For the compound of Formula (I), R₅ can be C₁₀ to C₂₀ alkyl or —R₅₀—NR₆R₇, R₅₀ can C₁ to C₅ alkylene, and R₆ and R₇ can independently be C₁ to C₆ alkyl. Additionally, the compounds of Formula (I) can have R₂₀ can be —C₂H₄—, and R₅₀ can be —C₃H₆6—.

Exemplary AA-LDHI of Formula (I) can have the following structures:

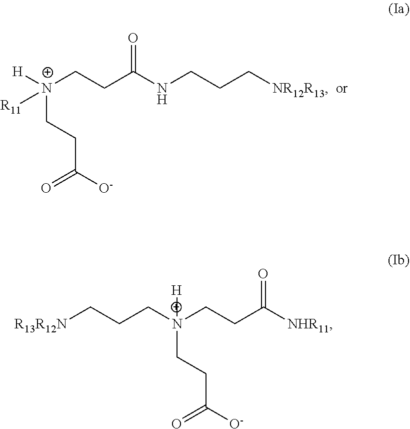

wherein R₁₁ is C₈ to C₂₀ alkyl, and R₁₂ and R₁₃ are independently C₁ to C₆ alkyl. In an embodiment, R₁₁ is C₁₂ to C₂₀ unsubstituted alkyl, and R₁₂ and R₁₃ are independently C₁ to C₄ unsubstituted alkyl. Further exemplary AA-LDHI of Formula (I) can be:

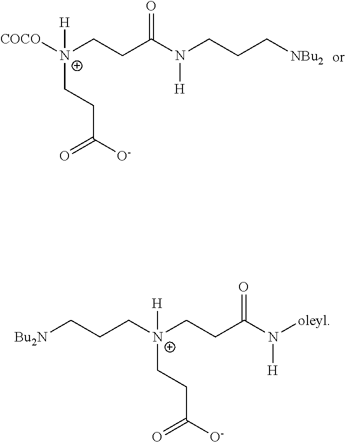

When the compound of Formula (I) is in salt form, the counterion can be selected from the group consisting of a halide, a carboxylate, hydrogen sulfate, dihydrogen phosphate, nitrate, and a combination thereof. In an exemplary embodiment, the counterion can be an acetate, an acrylate, or a combination thereof.

The cationic ammonium AA-LDHI included in the hydrate inhibitor and corrosion inhibitor compositions can include a compound of Formulae (IIa) or (IIb):

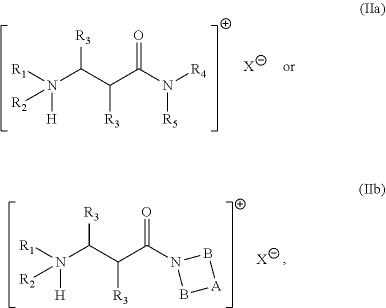

wherein R₁ is an alkyl group or alkenyl group that can contain one or more heteroatoms or ionizable heteroatoms, R₂ is present or not as hydrogen, depending on the ionization of the attached nitrogen atom, R₃ comprises a group selected from the generic formula CₙH₂ₙ₊₁, wherein n is a number from 0 to 10, R₄ is an alkyl group or alkenyl group that can contain one or more heteroatoms or ionizable heteroatoms, R₅ is selected from the group consisting of hydrogen, an alkyl group that can contain one or more heteroatoms or ionizable heteroatoms, an alkenyl group that can contain one or more heteroatoms or ionizable heteroatoms, and any combination thereof, B is a group selected from the generic formula (CH₂)ₙ, wherein n is a number from 1 to 4, A is a substituent selected from the group consisting of CH₂, NR₅, oxygen (O), and any combination thereof, and X is a counterion, such as a halide, any carboxylate, hydrogen sulfate, dihydrogen phosphate, or nitrate. Non-limiting examples include acetate and acrylate.

For the cationic ammonium compound AA-LDHI compounds of Formula (IIa) or (III)), R₁ can be any alkyl or alkenyl group that can contain one or more heteroatoms or ionizable heteroatoms. R₁ can comprise any group having from about 8 carbons atoms to about 20 carbon atoms, e.g. a C₈ to C₂₀ group. For example, R₁ can comprise a C₈ to C₁₂ group, a C₈ to C₁₂ group, a C₁₂ to C₁₆ group, a C₁₆ to C₂₀ group, or a C₁₈ to C₂₀ group.

For these cationic ammonium compound AA-LDHI compounds, the term “alkenyl” refers to a monovalent group derived from a straight, branched, or cyclic hydrocarbon containing at least one carbon-carbon double bond by the removal of a single hydrogen atom from each of two adjacent carbon atoms of an alkyl group. Representative alkenyl groups include, for example, ethenyl, propenyl, oleyl, butenyl, 1-methyl-2-buten-1-yl, and the like. For these cationic AA-LDHI compounds, the term “alkyl” refers to a monovalent group derived by the removal of a single hydrogen atom from a straight or branched chain or cyclic saturated or unsaturated hydrocarbon. Representative alkyl groups include methyl, ethyl, propyl, butyl, pentyl, hexyl, heptyl, octyl, nonyl, decyl, lauryl, and the like.

Further to the cationic ammonium compound AA-LDHI compounds described herein, Table 2 shows additional compounds that have been synthesized and intended to be included in the AA-LDHI of the present disclosure:

TABLE 2

| Example | R₁ | R₂ | R₄ | R₅ | B₁ | B₂ | X |
|---|---|---|---|---|---|---|---|
| 1 | oleyl | H | — | — | C₂H₄ | CH₂ | acetate |
| 2 | oleyl | H | — | — | C₂H₄ | CH₂ | sulfate |
| 3 | coco | H | — | — | C₂H₄ | CH₂ | acrylate |
| 4 | coco | H | C₃H₆(N(C₂H₄C(CH₃)₂)₂) | H | — | — | 2 × |
| | | | | | | | acetate |
| 5 | coco | — | C₃H₆(N(C₂H₄C(CH₃)₂)₂) | H | — | — | acetate |
| 6 | oleyl | H | C₃H₆(N(C₂H₄C(CH₃)₂)₂) | H | — | — | 2 × |
| | | | | | | | acetate |
| 7 | oleyl | H | C₃H₆(N(C₄H₉)₂)) | H | — | — | 2 × |
| | | | | | | | acetate |
| 8 | coco | — | C₃H₆(N(C₄H₉)₂)) | H | — | — | acrylate |
| 9 | oleyl | H | — | — | C₂H₄ | C₃H₆ | acetate |
| 10 | oleyl | H | — | — | C₂H₄ | C₃H₆ | acrylate |
| 11 | coco | H | — | — | C₂H₄ | C₃H₆ | sulfate |
| 12 | coco | H | C₄H₉ | C₄H₉ | — | — | acrylate |
| 13 | C₃H₆(N(C₂H₄C(CH₃)₂)₂) | H | oleyl | H | — | — | 2 × |
| | | | | | | | acetate |
| 14 | C₃H₆(N(C₂H₄C(CH₃)₂)₂) | — | coco | H | — | — | acrylate |
| 15 | C₃H₆(N(C₄H₉)₂)) | H | oleyl | H | — | — | 2 × |
| | | | | | | | acetate |
| 16 | C₃H₆(N(C₄H₉)₂)) | H | coco | H | — | — | 2 × |
| | | | | | | | acetate |

In connection with the specific compounds listed in Table 2 and the generic structures depicted above, R₃ was selected to be hydrogen and “A” was selected to be CH₂. Although the generic structure above only lists “B” as two of the substituents and Table 2 lists “B1” and “B2”, the generic structure is intended to cover wherein the “B1” substituent is located at either of the “B” group positions and the “B2” substituent is located at either of the “B” group positions.

Further exemplary cationic ammonium compound AA-LDHI of Formula (IIa) include the following general structure:

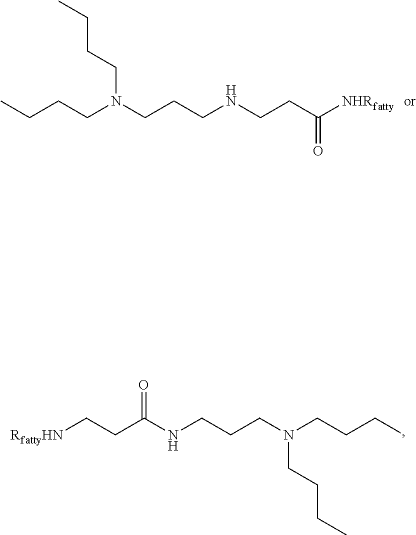

wherein R_{fatty} is any alkyl group having from about 8 carbon atoms to about 20 carbon atoms, e.g. a C₈ to C₂₀ group. For example, R_{fatty} can comprise a C₈ to C₁₂ group, a C₁₂ to C₁₆ group, or a C₁₆ to C₂₀ group. For this structure, R_{fatty} comprises a C₈ group, a C₁₀ group, a C₁₂ group, a C₁₈ group, or a C₂₀ group.

With respect to the term “hydrate-philic” used in the present disclosure when describing a certain portion of the hydrate inhibitor molecule, the portion of the molecule being referred to as the hydrate-philic portion is, with respect to the specific composition shown above, the portion opposite the R_{fatty} group. That is, in the above example, the portion including the tertiary N atom and the two butyl groups.

Further exemplary cationic ammonium compound AA-LDHI of Formula (IIb) include the following general structure:

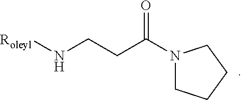

Additional cationic ammonium compound AA-LDHI included in the hydrate inhibitor and corrosion inhibitor compositions can include a compound of Formula (IIIa) or (IIIb):

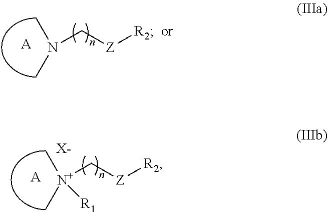

wherein A is an optionally substituted pyrrole, pyrrolidine, piperidine, pyrazole, imidazole, triazole, isoxazole, oxazole, thiazole, isothiazole, oxadiazole, oxatriazole, dioxazole, oxathiazole, pyridine, pyridazine, pyrimidine, pyrazine, triazine, oxazine, oxathiazine, oxazine, isoxazine, oxadiazine, morpholine, azepane, azepine, caprolactam, or quinoline; R₁ is hydrogen, optionally substituted alkyl, optionally substituted alkenyl, optionally substituted alkynyl, or optionally substituted aryl; R₂ is hydrogen, optionally substituted alkyl, alkenyl, or alkynyl; Z is —NR₃—C(O)—, —C(O)—NR₃—, —O—C(O)—, —C(O)—O—, —S—C(O)—, —C(O)—S—, —O—C(O)—NR₃—, —NR₃—C(O)—O—, —NR₃—C(O)—NR₃—, or absent; R₃ is hydrogen, optionally substituted alkyl, optionally substituted alkenyl, optionally substituted alkynyl, or optionally substituted aryl; n is an integer from 0 to 25; X⁻ is an anion; and when A is oxazolidine and R₂ is alkyl, Z is —NR₃—C(O)—, —C(O)—NR₃—, —O—C(O)—, —C(O)—O—, —S—C(O)—, —C(O)—S—, —O—C(O)—NR₃—, —NR₃—C(O)—O—, or —NR₃—C(O)—NR₃—.

The compound of Formula (IIIa) or (IIIb) can also have A as an optionally substituted nitrogen-containing heterocycle; R₁ is hydrogen, optionally substituted alkyl, optionally substituted alkenyl, optionally substituted alkynyl, or optionally substituted aryl; R₂ is hydrogen, optionally substituted alkyl, alkenyl, or alkynyl; Z as —NR₃—C(O)—, —O—C(O)—, —S—C(O)—, —C(O)—S—, —O—C(O)—NR₃—, —NR₃—C(O)—O, —NR₃—C(O)—NR₃—, or absent; R₃ is hydrogen, optionally substituted alkyl, optionally substituted alkenyl, optionally substituted alkynyl, or optionally substituted aryl; n is an integer from 0 to 25; X⁻ is an anion; and when A is oxazolidine, Z is —NR₃—C(O)—, —C(O)—NR₃—, —O—C(O)—, —C(O)—O—, —S—C(O)—, —C(O)—S—, —O—C(O)—NR₃—, —NR₃—C(O)—O—, or —NR₃—C(O)—NR₃—.

The optionally substituted nitrogen-containing heterocycle A of the compound of Formula (IIIa) or (IIIb) can be an optionally substituted pyrrole, pyrroline, pyrrolidine, piperidine, pyrazole, pyrazoline, pyrazolidine, imidazole, imidazoline, imidazolidine, triazole, isoxazole, isoxazoline, isoxazolidine, oxazole, oxazoline, oxazolidine, thiazole, isothiazole, oxadiazole, oxatriazole, dioxazole, oxathiazole, pyridine, pyridazine, pyrimidine, pyrazine, piperazine, triazine, oxazine, oxathiazine, oxazine, isoxazine, oxadiazine, morpholine, azepane, azepine, caprolactam, or quinoline.

Further, the optionally substituted nitrogen-containing heterocycle A of the compound of Formula (IIIa) or (IIIb) can be an optionally substituted five-membered nitrogen-containing heterocycle. For example, the five-membered nitrogen-containing heterocycle can be pyrrole, pyrroline, pyrrolidine, pyrazole, pyrazoline, pyrazolidine, imidazole, imidazoline, imidazolidine, isoxazole, isoxazoline, isoxazolidine, oxazole, oxazoline, or oxazolidine.

The compound of Formula (IIIa) or (IIIb) can have A as an optionally substituted pyrrole, pyrrolidine, piperidine, pyrazole, imidazole, pyridine, pyrimidine, piperazine, or morpholine.

The compound of Formula (IIIb) can comprise the compound of Formula (IIIb₂), (IIIb₅), (IIIb₆), (IIIb₇), (IIIb₈), (IIIb₉), or (IIIb₁₀):

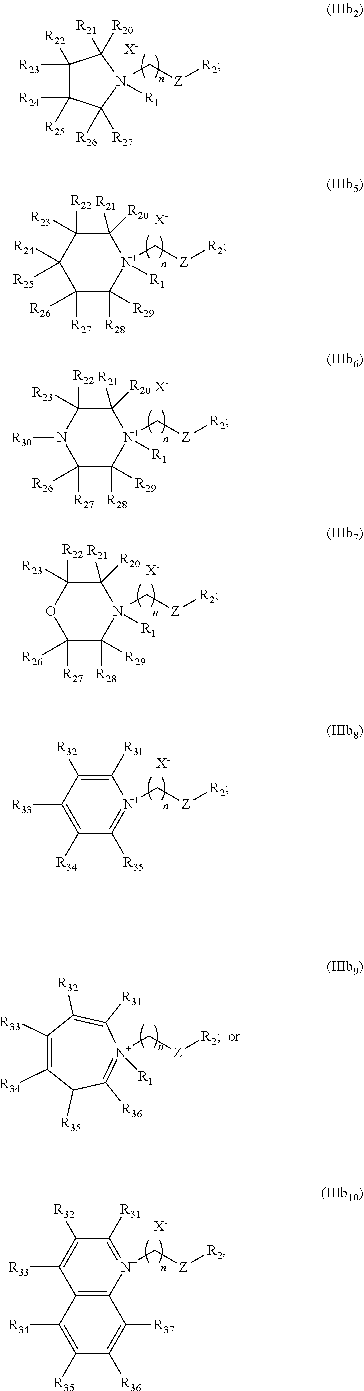

wherein n, Z, R₁, R₂, and X are as defined in connection with Formula (IIIb) and R₂₀, R₂₁, R₂₂, R₂₃, R₂₄, R₂₅, R₂₆, R₂₇, R₂₈, and R₂₉ are each independently hydrogen, alkyl, alkoxy, aminoalkyl, carboxyl, carboxyalkyl, alkenyl, alkenoxy; carboxyalkenyl, aryl, aryloxy, or carboxyaryl; R₃₀ is hydrogen, alkyl, or aryl; and R₃₁, R₃₂, R₃₃, R₃₄, R₃₅, R₃₆, and R₃₇ are each independently hydrogen, alkyl, alkoxy, aminoalkyl, carboxyl, carboxyalkyl, alkenyl, alkenoxy; carboxyalkenyl, aryl, aryloxy, or carboxyaryl.

Further exemplary cationic ammonium compound AA-LDHI of Formula (IIIb₂) include the following general structure:

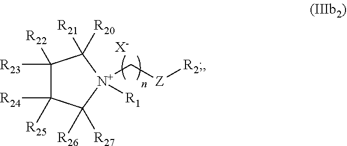

wherein R₂₀, R₂₁, R₂₂, R₂₃, R₂₄, R₂₅, R₂₆, and R₂₇ are hydrogen. Alternatively, R₂₀, R₂₁, R₂₂, R₂₃, R₂₄, R₂₅, and R₂₆, are hydrogen and R₂₇ is carboxyl. In additional embodiments as described herein R₁ is hydrogen, Z is —NR₃—C(O)— and R₃ is hydrogen.

Further exemplary cationic ammonium compound AA-LDHI of Formula (IIIb₅) include the following general structure:

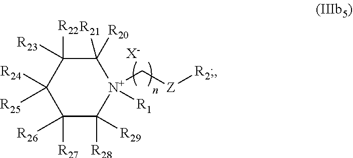

wherein R₂₀, R₂₁, R₂₂, R₂₃, R₂₄, R₂₅, R₂₆, R₂₇, R₂₈, and R₂₉ are hydrogen, Z is —NR₃—C(O)— or —C(O)—NR₃—, R₃ is hydrogen, R₂ is C₁₀-C₂₀ alkyl or alkenyl, and n is 2 or 3.

The compound of Formula (IIIa) can comprise the compound of Formula (IIIa₂), (IIIa₃), (IIIa₄), (IIIa₅), (IIIb₆), (IIIb₇), (IIIb₈), (IIIb₉), or (IIIb₁₁):

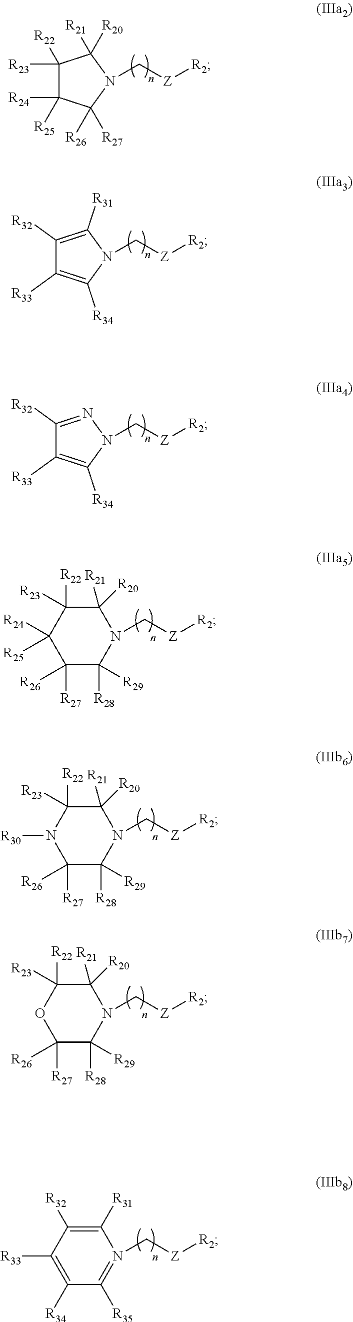

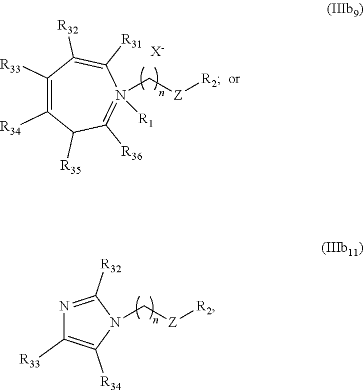

wherein n, Z, R₁, and R₂ are as defined in connection with Formula (IIIa) and R₂₀, R₂₁, R₂₂, R₂₃, R₂₄, R₂₅, R₂₆, R₂₇, R₂₈, and R₂₉ are each independently hydrogen, alkyl, alkoxy, aminoalkyl, carboxyl, carboxyalkyl, alkenyl, alkenoxy; carboxyalkenyl, aryl, aryloxy, or carboxyaryl; R₃₀ is hydrogen, alkyl, or aryl; and R₃₁, R₃₂, R₃₃, R₃₄, R₃₅, and R₃₆ are each independently hydrogen, alkyl, alkoxy, aminoalkyl, carboxyl, carboxyalkyl, alkenyl, alkenoxy; carboxyalkenyl, aryl, aryloxy, or carboxyaryl.

Further exemplary cationic AA-LDHI of Formula (IIIa) as described above can have R₂ as C₁₀-C₂₄ alkyl or alkenyl; Z as —NR₃—C(O)— or —C(O)—NR₃—; n as an integer from 0 to 12; and X⁻ as an organic anion.

Further exemplary cationic ammonium compound AA-LDHI of Formula (IIIa₃) include the following general structure:

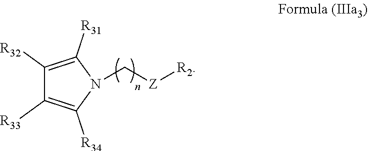

can have R₃₁, R₃₂, R₃₃, and R₃₄ are hydrogen, Z is —NR₃—C(O)— or —C(O)—NR₃—, R₃ is hydrogen, R₂ is C₁₀-C₂₀ alkyl or alkenyl, and n is 2 or 3.

Further exemplary cationic ammonium compound AA-LDHI of Formula (IIIa) or (IIIb) wherein: Z is —C(O)—NR₃— and R₃ is hydrogen; R₂ is C₁₀-C₂₀ alkyl or alkenyl, and n is 2 or 3; and/or wherein the anion is a halide, a carbonate, or a carboxylate anion.

As referred to herein, the AA-LDHIs when referring to a hydrate inhibitor in the present disclosure, it is to be understood that the reference can refer to a single AA-LDHI, or a combination of two or more AA-LDHI. In embodiments, the compositions include a single AA-LDHI. However in additional embodiments, the compositions include an AA-LDHI in combination with an additional hydrate inhibitor, such as an additional AA-LDHI. Additional disclosure of suitable AA-LDHIs is described in U.S. Pat. Nos. 9,410,073, 9,765,254, 10,281,086, and 10,435,616, each of which are herein incorporated by reference in their entirety.

In some embodiments the composition does not include any quaternary ammonium compound AA-LDHIs. In further embodiments the composition does not include any or halide-containing AA-LDHIs. In still further embodiments the composition does not include any quaternary ammonium compound AA-LDHIs or halide-containing AA-LDHIs.

In some embodiments, the AA-LDHI is included in the composition at an amount of at least about 10 wt-% to about 99.9 wt-%, 20 wt-% to about 99.9 wt-%, 30 wt-% to about 99.9 wt-%, 40 wt-% to about 99.9 wt-%, 50 wt-% to about 99.9 wt-%, about 60 wt-% to about 99.9 wt-%, about 70 wt-% to about 99.9 wt-%, about 75 wt-% to about 99.9 wt-%, about 80 wt-% to about 99.9 wt-%, or about 85 wt-% to about 99.9 wt-%. In addition, without being limited according to the disclosure, all ranges recited are inclusive of the numbers defining the range and include each integer within the defined range.

In some embodiments, the AA-LDHI is dosed with or combined with a composition comprising the corrosion inhibitor and other additional functional ingredients (i.e. corrosion inhibitor composition) at a weight ratio of up to about 1 part AA-LDHI to about 1 part corrosion inhibitor composition, or about 1:0.001 to about 1:1, about 1:0.005 to about 1:1, about 1:0.005 to about 1:0.01, or about 1:0.01 to about 1:1. In addition, without being limited according to the disclosure, all ranges recited are inclusive of the numbers defining the range and include each integer within the defined range.

### Corrosion Inhibitors

The composition comprises at least one corrosion inhibitor (CI). CIs include amines, including for example aromatic amines, aliphatic amines, heterocyclic amines or alkoxylated amines, amidoamines, quaternary amines or quaternary ammonium compounds, amides, imidazolines and imido imidazolines (referred to as fatty acid amine condensates and imido fatty acid amine condensates, respectively), imidazolinium compounds, pyridines, quinolines, phosphate esters, carboxylic acids or monomeric or oligomeric fatty acids, or combinations thereof. Generally preferred CIs include an imidazoline, imidazoline compound, a quaternary ammonium compound, a pyridinium compound, or a combination thereof.

Exemplary imidazolines can include an imidazoline derived from a diamine, such as ethylene diamine (EDA), diethylene triamine (DETA), triethylene tetraamine (TETA) etc. and a long chain fatty acid such as tall oil fatty acid (TOFA). The imidazoline can be an imidazoline of Formula (I) below or an imidazoline derivative. Representative imidazoline derivatives include an imidazolinium compound of Formula (II) below or a bis-quaternized compound of Formula (III) below.

The imidazoline of Formula (I) is as follows:

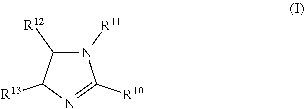

wherein R₁₀ is a C₁-C₂₀ alkyl or a C₁-C₂₀ alkoxyalkyl group; R¹¹ is hydrogen, C₁-C₆ alkyl, C₁-C₆ hydroxyalkyl, or C₁-C₆ arylalkyl; and R₁₂ and R₁₃ are independently hydrogen or a C₁-C₆ alkyl group. Preferably, the imidazoline includes an R¹⁰ which is the alkyl mixture typical in tall oil fatty acid (TOFA), and R¹¹, R₁₂ and R¹³ are each hydrogen.

The imidazolinium CI can include an imidazolinium compound of Formula (II):

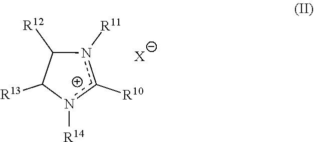

wherein R¹⁰ is a C₁-C₂₀ alkyl or a C₁-C₂₀ alkoxyalkyl group; R¹¹ and R¹⁴ are independently hydrogen, C₁-C₆ alkyl, C₁-C₆ hydroxyalkyl, or C₁-C₆ arylalkyl; R₁₂ and R₁₃ are independently hydrogen or a C₁-C₆ alkyl group; and X⁻ is a halide (such as chloride, bromide, or iodide), carbonate, sulfonate, phosphate, or the anion of an organic carboxylic acid (such as acetate). Preferably, the imidazolinium compound includes 1-benzyl-1-(2-hydroxyethyl)-2-tall-oil-2-imidazolinium chloride.

The CIs can comprise a bis-quaternized compound having the formula (III):

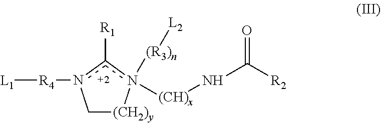

wherein: R₁ and R₂ are each independently unsubstituted branched, chain or ring alkyl or alkenyl having from 1 to about 29 carbon atoms; partially or fully oxygenized, sulfurized, and/or phosphorylized branched, chain, or ring alkyl or alkenyl having from 1 to about 29 carbon atoms; or a combination thereof; R₃ and R₄ are each independently unsubstituted branched, chain or ring alkylene or alkenylene having from 1 to about 29 carbon atoms; partially or fully oxygenized, sulfurized, and/or phosphorylized branched, chain, or ring alkylene or alkenylene having from 1 to about 29 carbon atoms; or a combination thereof; L₁ and L₂ are each independently absent, H, —COOH, —SO₃H, —PO₃H₂, —COOR₅, —CONH₂, —CONHR₅, or —CON(R₅)₂; R₅ is each independently a branched or unbranched alkyl, aryl, alkylaryl, alkylheteroaryl, cycloalkyl, or heteroaryl group having from 1 to about 10 carbon atoms; n is 0 or 1, and when n is 0, L₂ is absent or H; x is from 1 to about 10; and y is from 1 to about 5.

Preferably, R₁ and R₂ are each independently C₆-C₂₂ alkyl, C₈-C₂₀ alkyl, C₁₂-C₁₈ alkyl, C₁₆-C₁₈ alkyl, or a combination thereof; R₃ and R₄ are C₁-C₁₀ alkylene, C₂-C₈ alkylene, C₂-C₆ alkylene, or C₂-C₃ alkylene; n is 0 or 1; x is 2; y is 1; R₃ and R₄ are —C₂H₂—; L₁ is —COOH, —SO₃H, or —PO₃H₂; and L₂ is absent, H, —COOH, —SO₃H, or —PO₃H₂. For example, R₁ and R₂ can be derived from a mixture of tall oil fatty acids and are predominantly a mixture of C₁₇H₃₃ and C₁₇H₃₁ or can be C₁₆-C₁₈ alkyl; R₃ and R₄ can be C₂-C₃ alkylene such as —C₂H₂—; n is 1 and L₂ is —COOH or n is 0 and L₂ is absent or H; x is 2; y is 1; R₃ and R₄ are —C₂H₂—; and L₁ is —COOH.

It should be appreciated that the number of carbon atoms specified for each group of formula (III) refers to the main chain of carbon atoms and does not include carbon atoms that may be contributed by substituents.

The imidazoline Cis can comprise a bis-quaternized imidazoline compound having the formula (III) wherein R₁ and R₂ are each independently C₆-C₂₂ alkyl, C₈-C₂₀ alkyl, C₁₂-C₁₈ alkyl, or C₁₆-C₁₈ alkyl or a combination thereof; R₄ is C₁-C₁₀ alkylene, C₂-C₈ alkylene, C₂-C₆ alkylene, or C₂-C₃ alkylene; x is 2; y is 1; n is 0; L₁ is —COOH, —SO₃H, or —PO₃H₂; and L₂ is absent or H. Preferably, a bis-quaternized compound has the formula (III) wherein R₁ and R₂ are each independently C₁₆-C₁₈ alkyl; R₄ is —C₂H₂—; x is 2; y is 1; n is 0; L₁ is —COOH, —SO₃H, or —PO₃H₂ and L₂ is absent or H.

The CIs can be a quaternary ammonium compound of Formula (IV):

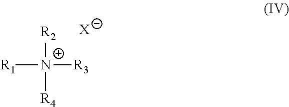

wherein R₁i, R₂, and R₃ are independently C₁ to C₂₀ alkyl, R₄ is methyl or benzyl, and X⁻ is a halide or methosulfate.

Suitable alkyl, hydroxyalkyl, alkylaryl, arylalkyl or aryl amine quaternary salts include those alkylaryl, arylalkyl and aryl amine quaternary salts of the formula [N⁺R₅ₐR₆ₐR₇ₐR^{8a}] [X⁻] wherein R₅ₐ, R^{6a}, R₇ₐ, and R₈ₐ contain one to 18 carbon atoms, and X is Cl, Br or I. For the quaternary salts, R₅ₐ, R₆ₐ, R₇ₐ, and R₈ₐ can each be independently alkyl (e.g., C₁-C₁₈ alkyl), hydroxyalkyl (e.g., C₁-C₁₈ hydroxyalkyl), and arylalkyl (e.g., benzyl). The mono or polycyclic aromatic amine salt with an alkyl or alkylaryl halide include salts of the formula [N³⁰ R^{5a}R^{6a}R^{7a}R^{8a}] [X⁻] wherein R₅ₐ, R^{6a}, R₇ₐ, and R₈ₐ contain one to 18 carbon atoms and at least one aryl group, and X is Cl, Br or I.

Suitable quaternary ammonium salts include, but are not limited to, a tetramethyl ammonium salt, a tetraethyl ammonium salt, a tetrapropyl ammonium salt, a tetrabutyl ammonium salt, a tetrahexyl ammonium salt, a tetraoctyl ammonium salt, a benzyltrimethyl ammonium salt, a benzyltriethyl ammonium salt, a phenyltrimethyl ammonium salt, a phenyltriethyl ammonium salt, a cetyl benzyldimethyl ammonium salt, a hexadecyl trimethyl ammonium salt, a dimethyl alkyl benzyl quaternary ammonium salt, a monomethyl dialkyl benzyl quaternary ammonium salt, or a trialkyl benzyl quaternary ammonium salt, wherein the alkyl group has about 6 to about 24 carbon atoms, about 10 and about 18 carbon atoms, or about 12 to about 16 carbon atoms. The quaternary ammonium salt can be a benzyl trialkyl quaternary ammonium salt, a benzyl triethanolamine quaternary ammonium salt, or a benzyl dimethylaminoethanolamine quaternary ammonium salt.

The quaternary ammonium CIs can comprise a pyridinium salt such as those represented by Formula (V):

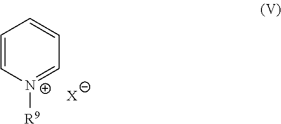

wherein R₉ is an alkyl group, an aryl group, or an arylalkyl group, wherein said alkyl groups have from 1 to about 18 carbon atoms and X⁻ is a halide such as chloride, bromide, or iodide. Among these compounds are alkyl pyridinium salts and alkyl pyridinium benzyl quats. Exemplary compounds include methyl pyridinium chloride, ethyl pyridinium chloride, propyl pyridinium chloride, butyl pyridinium chloride, octyl pyridinium chloride, decyl pyridinium chloride, lauryl pyridinium chloride, cetyl pyridinium chloride, benzyl pyridinium chloride and an alkyl benzyl pyridinium chloride, preferably wherein the alkyl is a C₁-C₆ hydrocarbyl group. Preferably, the pyridinium compound includes benzyl pyridinium chloride.

Exemplary phosphate esters include, for example mono-, di- and tri-alkyl as well as alkylaryl phosphate esters and phosphate esters of mono, di, and triethanolamine typically contain between from 1 to about 18 carbon atoms. Preferred mono-, di- and trialkyl phosphate esters, alkylaryl or arylalkyl phosphate esters are those prepared by reacting a C₃-C₁₈ aliphatic alcohol with phosphorous pentoxide. The phosphate intermediate interchanges its ester groups with triethylphosphate producing a broader distribution of alkyl phosphate esters.

Alternatively, the phosphate ester can be made by admixing with an alkyl diester, a mixture of low molecular weight alkyl alcohols or diols. The low molecular weight alkyl alcohols or diols preferably include C₆ to C₁₀ alcohols or diols. Further, phosphate esters of polyols and their salts containing one or more 2-hydroxyethyl groups, and hydroxylamine phosphate esters obtained by reacting polyphosphoric acid or phosphorus pentoxide with hydroxylamines such as diethanolamine or triethanolamine are preferred.

Exemplary monomeric or oligomeric fatty acid CI include, for example, C₁₄-C₂₂ saturated and unsaturated fatty acids as well as dimer, trimer and oligomer products obtained by polymerizing one or more of such fatty acids.

Exemplary alkoxylated amine CI include, for example, ethoxylated alkyl amine. The alkoxylated amine can be ethoxylated tallow amine.

Additional CI can include an organic sulfur compound, such as a mercaptoalkyl alcohol, mercaptoacetic acid, thioglycolic acid, 3,3′-dithiodipropionic acid, sodium thiosulfate, thiourea, L-cysteine, tert-butyl mercaptan, sodium thiosulfate, ammonium thiosulfate, sodium thiocyanate, ammonium thiocyanate, sodium metabisulfite, or a combination thereof. Preferably, the mercaptoalkyl alcohol comprises 2-mercaptoethanol.

In some embodiments the composition can be substantially free of or free of any organic sulfur compound other than the compound of formula (1). A composition is substantially free of any organic sulfur compound if it contains an amount of organic sulfur compound less than 0.50 wt. % preferably less than 0.10 wt. %, and more preferably less than 0.01 wt. %.

Additional exemplary amines can include thiol-amines as disclosed in U.S. Pat. No. 11,242,480, which is incorporated herein by reference in its entirety. These thiol-amines include a class of anti-corrosion compounds having the formula:

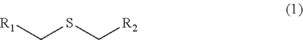

wherein: each R₁ is independently —CH₂OH and —C(O)OH; R₂ is

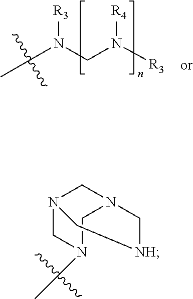

each R₃ is independently hydrogen or R₅, or both R₃ together form a ring via a linker

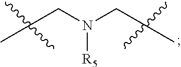

each R₄ is independently hydrogen or R₅;
R₅ is —CH₂SC₂H₄R₁; and
n is an integer from 0 to 3.

Preferably, when R₂ is

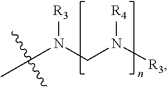

n is 0 and R₃ is hydrogen, R₁ is —CH₂OH.

The compound of formula (1) can have R₁ be —CH₂OH or —C(O)OH and R₂ be

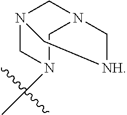 [SMILES: *N1CN2CNCN(C1)C2]

The compound of formula (1) can have R₁ be —CH₂OH or —C(O)OH; R₂ be

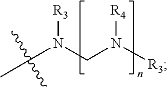

both R₃ together form a ring via linker

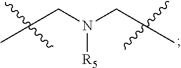

R₄ be hydrogen; R₅ be —CH₂SC₂H₄R₁; and n be 1.

The compound of formula (1) can have R₁ be —CH₂OH or —C(O)OH; R₂ be

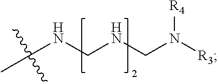

R₃ and R₄ be R₅; and R₅ be —CH₂SC₂H₄R₁.

The compound of formula (1) can have R₁ be —CH₂OH or —C(O)OH; R₂ be

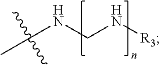

R₃ be hydrogen or R₅; R₅ is —CH₂SC₂H₄R₁; and n be 0 or 1. Preferably, R₃ is hydrogen and n is 0, or R₃ is R₅; R₅ is —CH₂SC₂H₄R₁; and n is 1.

Representative compounds of formula (1) derived from the reaction of hexamethylenetetramine (HMTA) and 2-mercaptoethanol (2-ME) include:

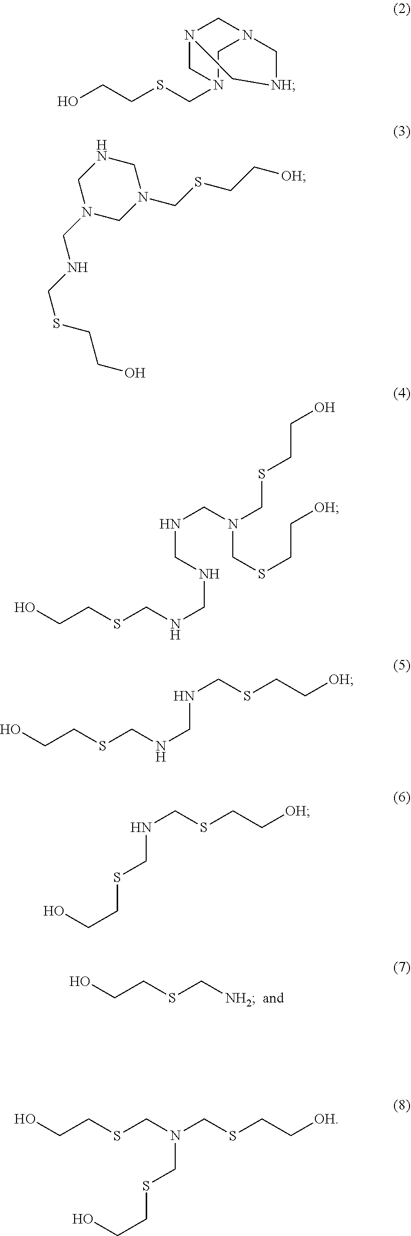

Representative compounds of formula (1) derived from the reaction of hexamethylenetetramine and thiolglycolic acid (TGA) include:

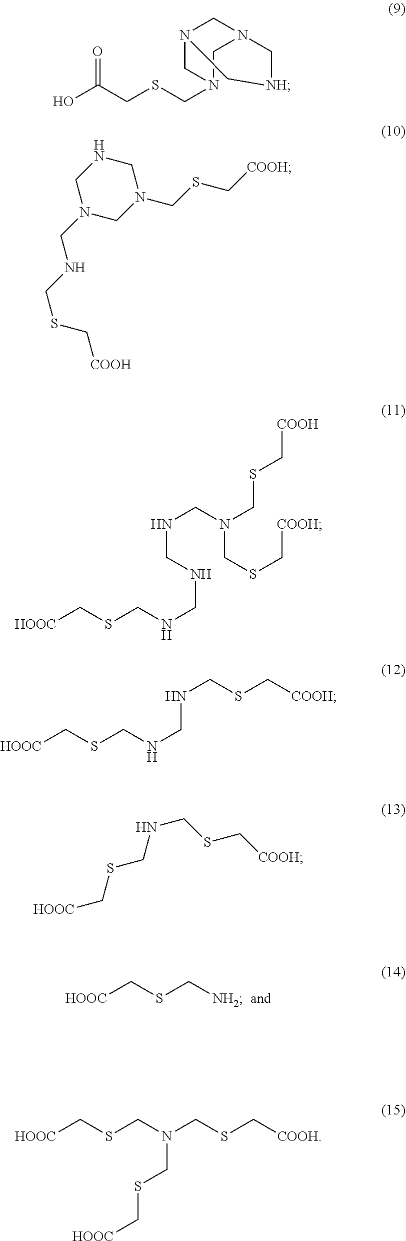

In preferred embodiments, more than one CI is included in the composition include a quaternary ammonium compound (e.g. benzyl alkyl quats, amine quats), an imidazoline, and at least one organic sulfur compound. In further embodiments the organic sulfur compound includes at least one of mercaptoalkyl alcohol, mercaptoacetic acid, and/or thioglycolic acid.

In preferred embodiments, more than one CI is included in the composition include a quaternary ammonium compound, an imidazoline, a phosphate ester and at least one organic sulfur compound. In further embodiments the organic sulfur compound includes at least one of mercaptoalkyl alcohol, mercaptoacetic acid, and/or thioglycolic acid.

In embodiments, the CI does not include any boron-hydroxylalkyl(amine) compounds. In further embodiments, the CI does not include any urea corrosion inhibitors. In further embodiments, the CI does not include any calcium nitrate corrosion inhibitors. In still further embodiments, the CI does not include any boron-hydroxylalkyl(amine) compounds, urea corrosion inhibitors and calcium nitrate corrosion inhibitors.

In some embodiments, the CI(s) is included in the composition at an amount of at least about 0.001 wt-% to about 50 wt-%, about 0.005 wt-% to about 50 wt-%, about 0.01 wt-% to about 50 wt-%, about 0.01 wt-% to about 40 wt-%, about 0.01 wt-% to about 20 wt-%, about 0.1 wt-% to about 10 wt-%, or about 0.1 wt-% to about 10 wt-%. In addition, without being limited according to the disclosure, all ranges recited are inclusive of the numbers defining the range and include each integer within the defined range.

In some embodiments, the CI(s) or a composition comprising the CI(s) with additional functional ingredients (i.e. corrosion inhibitor composition) can be dose with the AA-LDHI at a weight ratio of up to about 1 part AA-LDHI to about 1 part corrosion inhibitor composition, or about 1:0.001 to about 1:1, about 1:0.005 to about 1:1, about 1:0.005 to about 1:0.01, or about 1:0.01 to about 1:1. In addition, without being limited according to the disclosure, all ranges recited are inclusive of the numbers defining the range and include each integer within the defined range.

### Solvents

In some embodiments, the composition comprises at least one solvent. The solvents can include one or more polar or nonpolar solvents or a mixture thereof. Representative polar solvents suitable for compositions include water, brine, seawater, alcohols (including straight chain or branched aliphatic such as methanol, ethanol, propanol, isopropanol, butanol, 2-ethylhexanol, hexanol, octanol, decanol, 2-butoxyethanol, etc.), glycols and derivatives (ethylene glycol, methylene glycol, 1,2-propylene glycol, 1,3-propylene glycol, diethyleneglycol monomethyl ether, ethylene glycol monobutyl ether, ethylene glycol dibutyl ether, etc.), ketones (cyclohexanone, diisobutylketone), N-methylpyrrolidinone (NMP), N,N-dimethylformamide, and the like. Representative non-polar solvents suitable for formulation with the hydrate inhibitor composition include aliphatics, such as pentane, hexane, cyclohexane, methylcyclohexane, heptane, decane, dodecane, diesel, and the like, and aromatics, such as toluene, xylene, heavy aromatic naphtha, cyclohexanone, diisobutylketone, diethyl ether, propylene carbonate, N-methylpyrrolidinone, N,N-dimethylformamide, fatty acid derivatives (acids, esters, amides), and the like.

Preferably, the composition further comprises one or more solvents selected from the group consisting of water, isopropanol, methanol, ethanol, 2-ethylhexanol, heavy aromatic naphtha, toluene, ethylene glycol, ethylene glycol monobutyl ether (EGMBE), diethylene glycol monoethyl ether, xylene, or any combination thereof.

In embodiments the composition includes water an additional solvent.

In some embodiments, where a solvent(s) is included in the composition it is included at an amount of at least about 0.0001 wt-% to about 10 wt-%, about 0.001 wt-% to about 10 wt-%, about 0.01 wt-% to about 5 wt-%, or about 0.1 wt-% to about 1 wt-%. In addition, without being limited according to the disclosure, all ranges recited are inclusive of the numbers defining the range and include each integer within the defined range.

In other embodiments, the solvent(s) can be included in a composition with the CI(s) and other additional functional ingredients that is combined at a point of use with the AA-LDHI. In such embodiments where the AA-LDHI is not included in the same composition, the solvent is included at an amount of at least about 1 wt-% to about 40 wt-%, about 5 wt-% to about 40 wt-%, about 10 wt-% to about 40 wt-%, or about 20 wt-% to about 40 wt-%. In addition, without being limited according to the disclosure, all ranges recited are inclusive of the numbers defining the range and include each integer within the defined range.

### Additional Functional Ingredients

The components of the composition can further be combined with various functional components suitable for uses disclosed herein. In some embodiments, the compositions including the anti-agglomerant low dose hydrate inhibitor, corrosion inhibitor(s) and solvent make up a large amount, or even substantially all of the total weight of the compositions. For example, in some embodiments few or no additional functional ingredients are disposed therein.

In other embodiments, additional functional ingredients may be included in the compositions to combine with the anti-agglomerant low dose hydrate inhibitor, corrosion inhibitor(s) and solvent. The functional ingredients provide desired properties and functionalities to the compositions. For the purpose of this application, the term “functional ingredient” includes a material that when dispersed or dissolved in a use and/or concentrate solution, such as an aqueous solution, provides a beneficial property in a particular use. Some particular examples of functional materials are discussed in more detail below, although the particular materials discussed are given by way of example only, and that a broad variety of other functional ingredients may be used.

In some embodiments, the compositions may include asphaltene inhibitors, paraffin inhibitors, additional corrosion inhibitors, scale inhibitors, emulsifiers, water clarifiers, dispersants, emulsion breakers, biocides, pH modifiers, surfactants, or any combination thereof and the like.

These additional ingredients can be pre-formulated with the compositions (either the composition with the anti-agglomerant low dose hydrate inhibitor, corrosion inhibitor(s) and solvent, or a separate composition with the corrosion inhibitor(s) and solvent, wherein the anti-agglomerant low dose hydrate inhibitor is added separately) or added to the use solution before, after, or substantially simultaneously with the addition of the compositions.

According to embodiments of the disclosure, the various additional functional ingredients may be provided in a composition in the amount from about 0 wt-% and about 30 wt-%, from about 0 wt-% and about 25 wt-%, from about 0 wt-% and about 20 wt-%, from about 0.01 wt-% and about 20 wt-%, from about 0.1 wt-% and about 10 wt-%, from about 1 wt-% and about 10 wt-%, from about 0.01 wt-% and about 8 wt-%, or from about 0.1 wt-% and about 8 wt. In addition, without being limited according to the disclosure, all ranges recited are inclusive of the numbers defining the range and include each integer within the defined range.

### Emulsion Breakers

In some embodiments the compositions may include an emulsion breakers. Suitable emulsion breakers include, but are not limited to, dodecylbenzylsulfonic acid (DDBSA), the sodium salt of xylenesulfonic acid (NAXSA), epoxylated and propoxylated compounds, anionic, cationic and nonionic surfactants, including for example nonylphenols and nonylphenol ethoxylates, and resins, such as phenolic and epoxide resins.

In an exemplary embodiment the additional functional ingredient comprises an emulsion breaker in an amount from about 0.01 wt-% and about 10 wt-%, from about 0.1 wt-% and about 10 wt-%, from about 1 wt-% and about 10 wt-%, or from about 1 wt-% and about 8 wt-% when included in a composition with the CI (wherein the AA-LDHI is provided separately). In an exemplary embodiment where the components are provided in a single composition the emulsion breaker is in an amount from about 0.0001 wt-% and about 5 wt-%, from about 0.001 wt-% and about 2 wt-%, or from about 0.01 wt-% and about 2 wt-% of the composition.

### METHODS OF USE

According to embodiments, the compositions for inhibiting corrosion and gas hydrate agglomeration to effectively control corrosion, including both general and localized corrosion, and gas hydrate formation and plugging in hydrocarbon production and transportation systems are disclosed herein. As referred to herein, compositions comprising the AA-LDHI and CI(s) can be provided in a single composition to contact a fluid in need of treatment for inhibiting corrosion and formation of gas hydrate agglomerants. In referring to compositions, the scope of the disclosure also includes combining more than one input (i.e. composition) for the treatment of a fluid to inhibit corrosion and formation of gas hydrate agglomerants. For example, in some embodiments the AA-LDHI can be separately dosed or combined with a composition comprising the CI(s), solvent and/or additional functional ingredients. Similarly the AA-LDHI can be combined with CI(s), solvents and/or additional functional ingredients.

In embodiments where the AA-LDHI contacts a fluid in need of treatment to inhibit corrosion and formation of gas hydrate agglomerants from a separate composition from the CI(s), the AA-LDHI and corrosion inhibitor are provided at a weight ratio of up to about 1 part AA-LDHI to about 1 part corrosion inhibitor composition, or about 1:0.001 to about 1:1, about 1:0.005 to about 1:1, about 1:0.005 to about 1:0.01, or about 1:0.01 to about 1:1. In addition, without being limited according to the disclosure, all ranges recited are inclusive of the numbers defining the range and include each integer within the defined range.

The methods may be applied to a fluid to prevent, reduce or mitigate corrosion (as referred to herein including both localized and general) and the plugging of conduits, pipes, transfer lines, valves, and other places or equipment where hydrate agglomerates may form. Beneficially, for the corrosion inhibition both localized and generalized corrosion are reduced, including a general corrosion rate (GCR) of ≤4 mpy, and more preferably ≤3 mpy, and minimal or reduced pitting. In some embodiments, reduced pitting resulting from reduced localized corrosion can include reduction in quantity and depth of pitting compared to use of conventional CIs. In some embodiments, the methods reduce pitting at depths above about 20 mm.

The mils penetration per year (MPY) is used as an estimated general corrosion rate. The MPY is calculated from the following equation:

$$MPY = ( Δ M [ g ] \cdot C ) / ( ρ [ \frac{g}{{cm}^{2}} ] \cdot A [ {in}^{2} ] \cdot t [ hr ] )$$

where ΔM is the mass loss of the coupon at the end of the test in grams, C is a constant equal to 534000, ρ is the density of the coupon in g/cm², A is the surface area of the coupon in cm², and t is the exposure time in hours.

The methods may be applied to fluids moved through conduits, pipes, transfer lines, valves, and other places or equipment where hydrocarbon hydrate solids can form and corrosion can occur.

The methods including contacting the compositions to a fluid. Fluids include aqueous medium comprising water, gas, and/or optionally liquid hydrocarbons. The method comprises adding to the fluid an effective amount of the composition comprising the anti-agglomerant low dose hydrate inhibitor (AA-LDHI), wherein the AA-LDHI is a zwitterionic compound or a cationic ammonium compound, and corrosion inhibitor(s). In embodiments the fluids are contained in an oil or gas pipeline or refinery, including offshore applications.

In embodiments, the compositions and methods are effective to control corrosion and gas hydrate formation and plugging during hydrocarbon production and transportation. Specifically, the compositions can be injected prior to substantial formation of hydrates. An exemplary injection point for petroleum production operations is downhole near the surface controlled sub-sea safety valve. This ensures that during a shut-in, the product is able to disperse throughout the area where hydrates will occur. Treatment can also occur at other areas in the flowline, taking into account the density of the injected fluid. If the injection point is well above the hydrate formation depth, then the hydrate inhibitor can be formulated with a solvent having a density high enough that the inhibitor will sink in the flowline to collect at the water/oil interface. Moreover, the treatment can also be used in pipelines or anywhere in the system where the potential for corrosion and hydrate formation exists.

In embodiments, the fluid is contained in an oil and gas pipeline. Additionally, the fluid can be contained in refineries, such as separation vessels, dehydration units, gas lines, and pipelines.

Further, the compositions can be applied to a fluid that contains various levels of salinity. The fluid can have a salinity of about 0% to about 25%, or about 10% to about 25% weight/weight (w/w) total dissolved solids (TDS). The fluid in which the compositions are applied can be contained in many different types of apparatuses, especially those that transport an aqueous medium from one location to another.

The composition can be applied to a fluid that contains various levels of water cut. One of ordinary skill in the art understands that “water cut” refers to the % of water in a composition containing an oil and water mixture. In particular, the water cut of the fluid can be from about 1% to about 90% w/w, or from about 1% to about 80% w/w based on the total weight of the fluid comprising water, gas, and/or optionally liquid hydrocarbon.

The compositions are applied at an effective amount to inhibit general and localized corrosion and formation of gas hydrate agglomerants in the fluid. The dosage amounts of the compositions described herein to be added to the fluid can be tailored by one skilled in the art based on factors for each fluid in need of treatment, including, for example, content of fluid, percentage water cut, API gravity of hydrocarbon, and test gas compositions. In embodiments, an effective amount is from about 0.1% to about 10% v/v (volume percentage) based on an amount of the total composition described herein and the amount of fluid that is treated. In further embodiments, an effective amount is from about 0.1% to about 5% v/v, from about 0.5% to about 5% v/v, or from about 0.75% to about 2% v/v, based on an amount of the total composition described herein and the amount of fluid that is treated.

The compositions can be applied to a fluid using various well-known methods and they can be applied at numerous different locations throughout a given system. The composition can be pumped into an oil/gas pipeline using an umbilical line. Further, capillary string injection systems can be utilized to deliver the composition. U.S. Pat. No. 7,311,144 provides a description of an apparatus and methods relating to capillary injection, the disclosure of which is incorporated into the present application in its entirety.

### EXAMPLES

Embodiments of the present disclosure are further defined in the following non-limiting Examples. It should be understood that these Examples, while indicating certain embodiments of the disclosure, are given by way of illustration only. From the above discussion and these Examples, one skilled in the art can ascertain the essential characteristics of this disclosure, and without departing from the spirit and scope thereof, can make various changes and modifications of the embodiments of the disclosure to adapt it to various usages and conditions. Thus, various modifications of the embodiments of the disclosure, in addition to those shown and described herein, will be apparent to those skilled in the art from the foregoing description. Such modifications are also intended to fall within the scope of the appended claims.

### Example 1

### Rocking Cell Hydrate Performance Testing

The combinations of AA-LDHI and CIs shown in Table 3 were evaluated in this Example. The AA-LDHI and CI ratios were fixed across all combination products trialed using higher (95-99.5) vol % of the AA-LDHI and low (0.5-5%) vol % of a mixture of varying corrosion inhibitor components. The variation in CIs in the evaluated products were controlled by including in the testing a total CI ppm concentration of 10,000 ppm.

TABLE 3

| Product | Additives Included |
|---|---|
| AA-LDHI/CI Combo | Fatty acid amine condensate, quaternary ammonium |
| Product 1 | compound, methanol, nonylphenol surfactant, sulfur compound |
| AA-LDHI/CI Combo | Imido fatty acid amine condensate, fatty pyridine derivative, |
| Product 2 | nonylphenol surfactant, sulfur compound |
| AA-LDHI/CI Combo | Quaternary ammonium compound, imido fatty acid amine |
| Product 3 | condensate, sulfur compound |
| AA-LDHI/CI Combo | Fatty pyridine derivative, fatty acid amine condensate, |
| Product 4 | methanol, sulfur compound |
| AA-LDHI/CI Combo | Quaternary ammonium compound, Imido fatty acid amine |
| Product 5 | condensate, nonylphenol surfactant, sulfur compound |
| AA-LDHI/CI Combo | Fatty acid amine condensate, quaternary ammonium |
| Product 6 | compound, sulfur compound |

Testing parameters are summarized in Table 4 and the composition of the synthetic gas (or Green Canyon gas) shows in Table 5.

TABLE 4

| Parameter | Value |
|---|---|
| Oil | Field Crude |
| API | 30 @ 60° F. |
| Gas | Synthetic Green Canyon Gas Blend (see Table 5) |
| Brine | 5.0 wt. % NaCl |
| AA-LDHI | AA-LDHI/CI Combo Products 1-6 (see Table 3) |
| Water Cut(s) | 30% |
| Test Equipment | Low Shear Automated Visual Rocking Cell |
| Pressure(s) | 2,000 psig |

TABLE 5

| Component | mol % |
|---|---|
| Methane | 87.2 |
| Ethane | 7.60 |
| Propane | 3.08 |
| n-Butane | 0.79 |
| i-Butane | 0.50 |
| n-Pentane | 0.20 |
| i-Pentane | 0.20 |
| Nitrogen | 0.39 |

The low shear automated visual rocking cell apparatus used for evaluation of low dosage hydrate inhibitors contains pressure cells made of sapphire tubes, each of which contains a stainless-steel ball. The cells are placed on a rack, and the rack is gently rocked up and then down using a computer-controlled stepper motor. The cells are charged with appropriate sample liquids prior to being placed in the rack and then immersed in the water bath. Once the cells are immersed in the bath, they can then be charged with gas to the desired pressure, and the experiment may begin. Sensors are used to monitor ball movement within the cells, with a sensor placed near each end of the cell: a top sensor, and a bottom sensor. The time it takes for the ball to travel from the top sensor to the bottom sensor in each cell, (i.e., ball travel time) is recorded.

The following parameters are recorded during low shear rocking cell tests:
1. Bath temperature
2. Individual cell pressure
3. Ball travel time (in seconds) as monitored by the sensors 1 (green) and 2 (red)
4. Visual observations

Hydrate formation or blockage is indicated by:
1. Increase in ball travel time
2. Pressure drop in constant volume test
3. Visual observation of hydrate particles in the cells

When evaluating the data, the results can indicate the following:
Fluid viscosity increase—Increase of ball falling time in both sensors indicates a fluid viscosity increase, which could be due to an increase of hydrate slurry concentration, or a viscosity increase of the liquid phase itself.
A partial plug—This is indicated by one sensor continuing to see ball movement while the other does not. A lack of ball movement is indicated by a sensor constantly seeing the ball (ball falling times are zero seconds) or by never seeing the ball (ball falling times are greater than or equal to 30 seconds).
A complete plug—This is indicated by a lack of ball movement from both sensors, constantly seeing the ball (ball falling times are zero seconds) or by never seeing the ball (ball falling times are greater than or equal to 30 seconds).

### Low Shear Automated Visual Rocking Cell Protocol

The rocking cell test protocol for a shut-in/restart simulation is outlined here:
1. Condition the oil at 176° F. (80° C.) for 2 h.
2. Charge the cell to 10 mL total volume with brine and crude oil.
3. Dose AA-LDHI into each cell. Displace the residual air in each cell by flushing with synthetic gas and venting three times.
4. Pressurize the cells to 2,000 psi at 80° F.
5. Cool the cells to 40° F. over a period of 4 hours while rocking.
6. Rock the cells for additional 6 hours at 40° F.
7. Simulate a shut-in by stopping the cells for a minimum of 16 h.
8. Simulate a restart by rocking the cells for a minimum of 2 h. Record visual observations.
9. End test.

Testing was performed using low shear hydrate rocking cells per standard shut in/restart protocol of an established field crude system. The results are summarized in Table 6. A passing dose rate is indicated by hydrate formation with no blockage occurring in the cell for the duration of the test. As per industry standard, replicate passes of any given dose rate were required to fully qualify as passing. Failure mechanisms vary, from blockage of the ball at any point during the test, to ball falls greater than 30 seconds, to the formation of endcap hydrates on the left and/or right side of the cell (confirmed by visual observation).

TABLE 6

| | | AA-LDHI | | |
|---|---|---|---|---|
| Water | AA-LDHI/CI | Dose Rate | | Pass |
| Cut (%) | Combo Product | (vol %) | Result | Rate |
| 30 | None | Blank | Fail | 0/1 |
| | AA-LDHI, no CI | 1.0 | Fail | 0/1 |
| | AA-LDHI, no CI | 1.5 | Pass | 2/2 |
| | AA-LDHI/CI Combo 1 | 1.0 | Fail | 0/1 |
| | AA-LDHI/CI Combo 1 | 1.5 | Pass | 2/2 |
| | AA-LDHI/CI Combo 2 | 1.0 | Fail | 0/1 |
| | AA-LDHI/CI Combo 2 | 1.5 | Pass | 2/2 |
| | AA-LDHI/CI Combo 3 | 1.0 | Fail | 0/1 |
| | AA-LDHI/CI Combo 3 | 1.5 | Pass | 2/2 |
| | AA-LDHI/CI Combo 4 | Not tested | N/A | N/A |
| | AA-LDHI/CI Combo 5 | 1.0 | Fail | 1/2 |
| | AA-LDHI/CI Combo 5 | 1.5 | Pass | 2/2 |
| | AA-LDHI/CI Combo 6 | 1.0 | Fail | 0/1 |
| | AA-LDHI/CI Combo 6 | 1.5 | Pass | 2/2 |

AA-LDHI/CI Combo 4 was not tested since it failed one of the product stability tests of the umbilical certification protocol. The data confirms that there is no interference in the hydrate inhibition of the AA-LDHI when combined with the various CIs.

### Example 2

### Cold Stress Testing—Corrosion Performance

The AA-LDHI/CI combination products in Table 3 were further evaluated for corrosion performance using 7-day rotating cage autoclave (RCA) testing. The corrosion performance was analyzed using RCA with the following testing methodology. Two pre-weighed and six additional Hastelloy coupons were mounted on a holder. The coupon holder was attached to the shaft and placed in a 2-liter autoclave that was previously de-aerated in three cycles using nitrogen. After closing the autoclave, the desired ratio of synthetic brine and hydrocarbon was introduced into the autoclave using vacuum. Chemical-free crude oil was utilized as the hydrocarbon phase. After heating the autoclave to the testing temperature, it was charged with the required amount of CO₂. The coupons were rotated for seven days at the speed corresponding to the target shear stress. After cooling down and depressurizing the autoclave, the coupons were removed, cleaned in inhibited acid solution, dried, and weighed to obtain mass loss for general corrosion rate calculation.

### Vertical Scanning Interferometry (VSI)

The post-test coupons were further evaluated for localized/pitting corrosion performance using VSI. A Bruker optical three-dimensional surface profilometer NPFlex-LA was used for characterizing corrosion coupon surface features. The VSI was applied to capture all features developed on the metal surface during the test. VSI provides noncontact, quantitative measurements with nanometer resolution on the vertical (Z) axis. The NPFlex-LA determines the size and shape of the surface features over the whole scan area. The corrosion coupons used in the study have a rectangular shape with 1×2×⅛″ dimensions. All surface features with a depth of 10 microns and deeper were captured in the scans. The depth is used as the metric for the surface analysis. Industry standard pitting corrosion performance pass/fail criteria allows one feature with a depth greater than 20 microns within the scan area of each coupon. Bruker optical three-dimensional surface profilometer NPFlex-LA was used to obtain VSI images, while the test parameters used for the corrosion testing are shown in Table 7. The water analysis of the brine composition had approximately a TDS of 90,000 and approximately 50,000 mg/L of chloride.

TABLE 7

| Parameters | Value |
|---|---|
| Water cut, % | 99 |
| Oil Type | Field Crude Oil |
| Temperature, | 160 (71) |
| ° F. (° C.) | |
| CO₂ Pressure, psig | (Contents purged with the gas in the autoclave |
| | before closing and no additional gas added) |
| Dosage, ppm | 10,000 ppm of combination product (chemical |
| | added on top of oil layer) |
| Time, hr | 168 |
| Shear Stress, Pa (rpm) | 40 (680 rpm) |
| Coupon Metallurgy and # | X-65, 2 |
| of flat coupons per test | |

The variation in CIs in the evaluated products were controlled by including in the testing a total CI ppm concentration of 10,000 ppm in combination with the AA-LDHI. The results are summarized in Table 8 These show that combination products 1-6 (except 4, not tested) generated ≤4 mpy general corrosion rates. The coupons were then scanned for localized/pitting corrosion and VSI data indicates that both AA-LDHI/CI-3 and AA-LDHI/CI-1 did not pass localized criteria (pit depths of ≤10 μm). Products 2, 5 and 6 were able to meet both general corrosion rate and localized criteria showing solid pitting prevention performance at the optimal dosages of 1% AA-LDHI/CI combination products.

TABLE 8

| | | | | Depth of |
|---|---|---|---|---|
| | | CR (mpy) | Average | Five deepest |
| | | each | CR | Features |
| Test | Chemical | coupon | (mpy) | (μm) |
| 1 | Blank | 105.89 | 103.1 | Not performed |
| | | 100.31 | | |
| 2 | Control AA-LDHI | 26.97 | 26.5 | Not performed |
| | | 26.03 | | |
| 3 | AA-LDHI/CI-1 | 0.95 | 0.98 | No features >10 μm |
| | | 1 | | 33.1, 29.8, 29.0, 28.1, 24.2 |
| 4 | AA-LDHI/CI-2 | 1.01 | 1.03 | No features >10 μm |
| | | 1.05 | | |
| 5 | AA-LDHI/CI-3 | 0.89 | 0.87 | 18.5, 17.2, 15.0, 14.5, 14.1 |
| | | 0.84 | | 39, 25.3, 24.5, 24.3, 23.4 |
| 6 | AA-LDHI/CI-4 | Not tested | Not tested | Not tested |
| 7 | AA-LDHI/CI-5 | 0.9 | 0.84 | No features >10 μm |
| | | 0.78 | | |
| 8 | AA-LDHI/CI- 6 | 1.19 | 1.11 | No features >10 μm |
| | | 1.04 | | |

Synergies were noted in AA-LDHI/CI combo products AA-LDHI/CI 2, AA-LDHI/CI 5, and AA-LDHI/CI 6.

It is to be understood that while the invention has been described in conjunction with the detailed description thereof, the foregoing description is intended to illustrate, and not limit the scope of the invention, which is defined by the scope of the appended claims. Other embodiments, advantages, and modifications are within the scope of the following claims. Any reference to accompanying drawings which form a part hereof, are shown, by way of illustration only. It is understood that other embodiments may be utilized and structural changes may be made without departing from the scope of the present disclosure. All publications discussed and/or referenced herein are incorporated herein in their entirety.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilized for realizing the invention in diverse forms thereof.

1. A hydrate inhibitor and corrosion inhibitor composition comprising:
from about 10 wt-% to about 99.9 wt-% of an anti-agglomerant low dose hydrate inhibitor (AA-LDHI), wherein the AA-LDHI is a zwitterionic compound or a cationic ammonium compound;
from about 0.01 wt-% to about 50 wt-% of a corrosion inhibitor, and
at least one additional functional ingredient, solvent, or a combination thereof.

2. The composition of claim 1, wherein the AA-LDHI is a zwitterionic compound having
the structure of Formula (I), or an acid, a free base, a zwitterion, or a salt thereof: 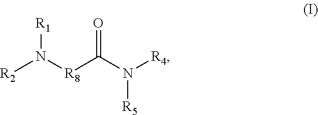
wherein:
R₁ is hydrogen, C₁-C₂₀ substituted or unsubstituted alkyl or alkenyl group;
R₂ is hydrogen, C₁-C₂₀ substituted or unsubstituted alkyl or alkenyl group, an alkylcarboxyl, or an alkylamido group;
R₄ and R₅ are independently hydrogen, C₁-C₂₀ substituted or unsubstituted alkyl or alkenyl group, or wherein the nitrogen atom and the R₄ and R₅ groups form a substituted or unsubstituted heterocyclo group; and
R₈ is a C₂-C₁₀ substituted or unsubstituted alkylene group.

3. The composition of claim 1, wherein the AA-LDHI is a cationic ammonium compound having the structure of Formulae (IIa) or (IIb): 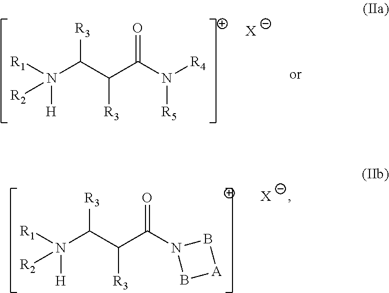
wherein:
R₁ is an alkyl group or alkenyl group, optionally having one or more heteroatoms or ionizable heteroatoms;
R₂ is absent or hydrogen;
R₃ is CₙH₂ₙ₊₁, wherein n is a number from 0 to 10;
R₄ is an alkyl group or alkenyl group, optionally having one or more heteroatoms or ionizable heteroatoms;
R₅ is hydrogen, or an alkyl or alkenyl group, optionally having one or more heteroatoms or ionizable heteroatoms;
B is a group selected from the generic formula (CH₂)ₙ, wherein n is a number from 1 to 4;
A is a substituent selected from the group consisting of CH₂, NR₅, oxygen (O), and any combination thereof, and
X is a counterion.

4. The composition of claim 1, wherein the AA-LDHI is a cationic ammonium compound having the structure of Formulae (IIIa) or (IIIb): 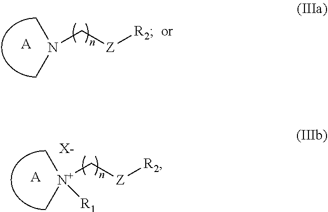
wherein:
A is an optionally substituted pyrrole, pyrrolidine, piperidine, pyrazole, imidazole, triazole, isoxazole, oxazole, thiazole, isothiazole, oxadiazole, oxatriazole, dioxazole, oxathiazole, pyridine, pyridazine, pyrimidine, pyrazine, triazine, oxazine, oxathiazine, oxazine, isoxazine, oxadiazine, morpholine, azepane, azepine, caprolactam, or quinoline;
R₁ is hydrogen, optionally substituted alkyl, optionally substituted alkenyl, optionally substituted alkynyl, or optionally substituted aryl;
R₂ is hydrogen, optionally substituted alkyl, alkenyl, or alkynyl; Z is —NR₃—C(O)—, —C(O)—NR₃—, —O—C(O)—, —C(O)—O—, —S—C(O)—, —C(O)—S—, —O—C(O)—NR₃—, —NR₃—C(O)—O—, —NR₃—C(O)—NR₃—, or absent;
R₃ is hydrogen, optionally substituted alkyl, optionally substituted alkenyl, optionally substituted alkynyl, or optionally substituted aryl;
n is an integer from 0 to 25;
X⁻ is an anion; and
when A is oxazolidine and R₂ is alkyl, Z is —NR₃—C(O)—, —C(O)—NR₃—, —O—C(O)—, —C(O)—O—, —S—C(O)—, —C(O)—S—, —O—C(O)—NR₃—, —NR₃—C(O)—O—, or —NR₃—C(O)—NR₃—.

5. A hydrate inhibitor and corrosion inhibitor composition comprising:
from about 10 wt-% to about 99.9 wt-% of an anti-agglomerant low dose hydrate inhibitor (AA-LDHI);
from about 0.01 wt-% to about 50 wt-% of a corrosion inhibitor, and
at least one additional functional ingredient, solvent, or a combination thereof, wherein the AA-LDHI is one of (a), (b), or (c):
(a) a zwitterionic compound having the structure of Formula (I), or an acid, a free base, a zwitterion, or a salt thereof: 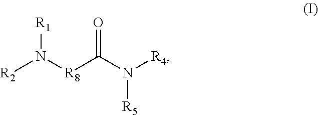
wherein:
R₁ is hydrogen, C₁-C₂₀ substituted or unsubstituted alkyl or alkenyl group;
R₂ is hydrogen, C₁-C₂₀ substituted or unsubstituted alkyl or alkenyl group, an alkylcarboxyl, or an alkylamido group;
R₄ and R₅ are independently hydrogen, C₁-C₂₀ substituted or unsubstituted alkyl or alkenyl group, or wherein the nitrogen atom and the R₄ and R₅ groups form a substituted or unsubstituted heterocyclo group; and
R₈ is a C₂-C₁₀ substituted or unsubstituted alkylene group, or
(b) a cationic ammonium compound having the structure of Formulae (IIa) or (IIb): 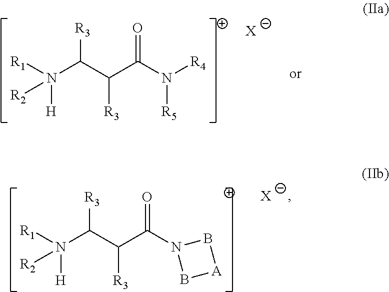
wherein:
R₁ is an alkyl group or alkenyl group, optionally having one or more heteroatoms or ionizable heteroatoms;
R₂ is absent or hydrogen;
R₃ is CₙH₂ₙ₊₁, wherein n is a number from 0 to 10;
R₄ is an alkyl group or alkenyl group, optionally having one or more heteroatoms or ionizable heteroatoms;
R₅ is hydrogen, or an alkyl or alkenyl group, optionally having one or more heteroatoms or ionizable heteroatoms;
B is a group selected from the generic formula (CH₂)ₙ, wherein n is a number from 1 to 4;
A is a substituent selected from the group consisting of CH₂, NR₅, oxygen (O), and any combination thereof, and
X is a counterion, or
(c) a cationic ammonium compound having the structure of Formulae (IIIa) or (IIIb): 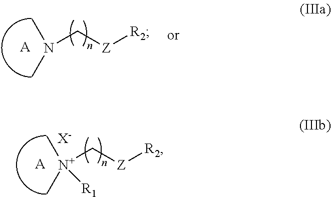
wherein:
A is an optionally substituted pyrrole, pyrrolidine, piperidine, pyrazole, imidazole, triazole, isoxazole, oxazole, thiazole, isothiazole, oxadiazole, oxatriazole, dioxazole, oxathiazole, pyridine, pyridazine, pyrimidine, pyrazine, triazine, oxazine, oxathiazine, oxazine, isoxazine, oxadiazine, morpholine, azepane, azepine, caprolactam, or quinoline;
R₁ is hydrogen, optionally substituted alkyl, optionally substituted alkenyl, optionally substituted alkynyl, or optionally substituted aryl;
R₂ is hydrogen, optionally substituted alkyl, alkenyl, or alkynyl; Z is —NR₃—C(O)—, —C(O)—NR₃—, —O—C(O)—, —C(O)—O—, —S—C(O)—, —C(O)—S—, —O—C(O)—NR₃—, —NR₃—C(O)—O—, —NR₃—C(O)—NR₃—, or absent;
R₃ is hydrogen, optionally substituted alkyl, optionally substituted alkenyl, optionally substituted alkynyl, or optionally substituted aryl;
n is an integer from 0 to 25;
X⁻ is an anion; and
when A is oxazolidine and R₂ is alkyl, Z is —NR₃—C(O)—, —C(O)—NR₃—, —O—C(O)—, —C(O)—O—, —S—C(O)—, —C(O)—S—, —O—C(O)—NR₃—, —NR₃—C(O)—O—, or —NR₃—C(O)—NR₃—.

6. The composition of claim 1, wherein The corrosion inhibitor is an aromatic amine, aliphatic amine, heterocyclic amine, alkoxylated amine, amidoamine, quaternary ammonium compound, amide, imidazoline, imidazolinium compound, pyridine, quinoline, phosphate ester, monomeric or oligomeric fatty acid, or any combination thereof.

7. The composition of claim 1, wherein the composition comprises more than one corrosion inhibitor, and/or does not include any boron-hydroxylalkyl(amine) compounds, urea or calcium nitrate corrosion inhibitors.

8. The composition of claim 7, wherein the corrosion inhibitors comprise (a) a quaternary ammonium compound, fatty acid amine condensate, and at least one sulfur compound; (b) a quaternary ammonium compound, fatty acid amine condensate, a phosphate ester, and at least one sulfur compound; (c) a quaternary ammonium compound, imido fatty acid amine condensate, nonylphenol/nonionic surfactant, and at least one sulfur compound; or (d) imido imidazoline, alkyl pyridine derivative, nonylphenol/nonionic surfactant, and at least one sulfur compound, and wherein the sulfur compound is an organic sulfur compound comprising at least one of mercaptoalkyl alcohol, mercaptoacetic acid, and/or thioglycolic acid.

9. The composition of claim 1, wherein the composition includes a single AA-LDHI.

10. The composition of claim 1, wherein the composition does not include any quaternary ammonium compound AA-LDHIs or halide-containing AA-LDHIs.

11. The composition of claim 1, wherein the solvent comprises a polar and/or nonpolar solvent.

12. The composition of claim 1, wherein the additional functional ingredient comprising one or more asphaltene inhibitors, paraffin inhibitors, scale inhibitors, emulsifiers, water clarifiers, dispersants, emulsion breakers, biocides, pH modifiers, surfactants, or any combination thereof.

13. The composition of claim 1, wherein the composition is free of kinetic hydrate inhibitors and fluoroalkyl compounds.

14. The composition of claim 1, wherein the composition is a two-part composition wherein the first part comprises the AA-LDHI and the second part comprises the corrosion inhibitor and the additional functional ingredient, solvent or combination thereof.

15. A method for inhibiting corrosion and formation of gas hydrate agglomerants in a fluid comprising:
contacting the fluid with a hydrate inhibitor and corrosion inhibitor composition of claim 1, or
contacting the fluid with an anti-agglomerant low dose hydrate inhibitor (AA-LDHI), wherein the AA-LDHI is a zwitterionic compound or a cationic ammonium compound, and a corrosion inhibitor, wherein the AA-LDHI and corrosion inhibitor are provided at a weight ratio of about 1:0.001 to about 1:1,
wherein the composition inhibits general and localized corrosion and formation of gas hydrate agglomerants in the fluid.

16. The method of claim 15, wherein the fluid comprises water, gas, and/or a hydrocarbon.

17. The method of claim 15, wherein the fluid is contained in an oil or gas pipeline or refinery.

18. The method of claim 17, wherein the oil or gas pipeline or refinery is an offshore application.

19. The method of claim 15, wherein the effective amount is from about 0.1 to about 5 volume %, based on an amount of fluid that is treated.

20. The method of claim 15, wherein the fluid has a water cut from about 1 to about 90 v/v percent.

21. The method of claim 15, wherein the inhibition of localized corrosion reduces pitting on surfaces and provides general corrosion rate of ≤4 mpy.
